(19) United States
(12) Patent Application Publication
(10) Pub. No.: US 2024/0013161 A1
(43) Pub. Date: Jan. 11, 2024

(54) SYSTEMS AND METHODS OF GUIDED APPLIANCE PART INSTALLATION AND REPAIR

(71) Applicant: Haier US Appliance Solutions, Inc., Wilmington, DE (US)

(72) Inventors: Haitian Hu, Louisville, KY (US); Hairong Li, Louisville, KY (US); Steven Keith Root, Buckner, KY (US)

(21) Appl. No.: 17/857,428

(22) Filed: Jul. 5, 2022

(51) Int. Cl. G06Q 10/00; G06T 15/00; G06T 7/60; G06Q 10/08

(52) U.S. Cl. CPC G06Q 10/20; G06T 15/00; G06T 7/60; G06Q 10/083

(57) ABSTRACT

An appliance repair instruction method for directing a user to perform a repair on an appliance is provided. The method includes the steps of receiving a request for appliance-specific repair instructions, obtaining an image of the appliance, the image including a portion of the appliance, generating an instructional overlay image including an instructional graphic associated with the image received to communicate at least one step of the appliance-specific repair instructions, and communicating the instructional overlay image. A method for directing a user to perform repairs on an appliance is provided that includes sending a request for appliance-specific repair instructions, sending an image of the appliance, and receiving an appliance-specific repair instruction step on a user device. A non-transitory computer readable medium capable of causing a processor of a controller to receive a request for appliance-specific instructions, obtain an image of the appliance, and generate an instructional overlay image is provided.

### FIELD OF THE INVENTION

The present subject matter relates generally to household appliances, and more particularly to household appliance repair.

### BACKGROUND OF THE INVENTION

Household appliances generally have components which may periodically need repair. Repairs to appliances are generally performed by a repair technician or by a user of the appliance. Some users prefer repairing appliances themselves, whether for additional flexibility in timing the repair, cost savings, or personal fulfillment.

Challenges exist in that an individual user may lack the experience or knowledge to handle a repair without a repair guide or instruction manual. Written text instructions may be difficult for users to navigate. Instructions or guides may be complicated or time consuming to read and understand. Some guides are written for multiple models, further requiring a user to manually select the correct sections of the guide during the installation. As a result, there may be a greater chance for a user to make errors when performing repairs to appliances. Further, users are generally unequipped to perform confirmation tests on their repairs to check the repair was completed correctly. For example, repair of parts with electrical connections may require an electrician to perform such tests to ensure the electrical connections of the appliance are robust following the repair.

Accordingly, improved guidance for users performing their own repairs would be beneficial. Additionally or alternatively, a repair aid that allows a user to perform a confirmation test on a repair would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, an appliance repair instruction method is provided. The appliance repair instruction method may include the steps of receiving a request for appliance-specific repair instructions, and obtaining an image of the appliance, the image including a portion of the appliance to be repaired following receipt of the request. The method may further include generating an instructional overlay image including an instructional graphic associated with the image received of the appliance to communicate at least one step of the appliance-specific repair instructions and communicating the instructional overlay image as a part of the appliance-specific repair instructions.

In another exemplary aspect of the present disclosure, an appliance repair instruction method for directing a user to perform repairs on an appliance is provided. The appliance repair instruction method may include the steps of sending a request for appliance-specific repair instructions, and sending an image of the appliance, the image including a portion of the appliance to be repaired. The method may further include receiving an appliance-specific repair instruction step on a user device. The appliance-specific repair instruction step may include an instructional over lay image which may include an instructional graphic associated with the image of the appliance sent. The instructional graphic may communicate at least one step of the appliance-specific repair instructions.

In another exemplary aspect of the present disclosure, a non-transitory computer readable medium is provided. The non-transitory computer readable medium may include computer-executable instructions, which, when executed by one or more processors of a computing system having a controller may cause the one or more processors of the controller to receive a request for appliance-specific repair instructions and obtain an image of an appliance. The image may include a portion of the appliance to be repaired following receipt of the request. The controller may further cause one or more processors to generate an instructional overlay image including an instructional graphic superimposed on the image received of the appliance to communicate at least one step of the appliance-specific repair instructions. The controller may also cause one or more processors to communicate a display of the instructional overlay image as a part of the appliance-specific repair instructions. The controller may also cause one or more processors to receive an installation confirmation that the portion of the appliance is repaired following communication of the at least one step of the appliance-specific repair instructions. The controller may also cause one or more processors to update an appliance repair history to include a record of a repair performed grouped with a unique identification value of the appliance following receipt of the installation confirmation.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a schematic view of an exemplary appliance repair guide system and interactive diagram according to exemplary embodiments of the present disclosure.

FIG. 2 provides a flow chart illustrating an exemplary appliance repair guide method according to exemplary embodiments of the present disclosure.

FIG. 3 provides a perspective view of an exemplary remote user device of the exemplary appliance repair guide system of FIG. 1.

FIG. 4 provides an exemplary appliance repair history chart of the exemplary appliance repair guide system of FIG. 1.

FIG. 5 provides a flow chart illustrating an alternate exemplary appliance repair guide method according to exemplary embodiments of the present disclosure

Use of the same of similar reference numerals in the figures denotes the same or similar features unless the context indicates otherwise.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components. Terms such as “inner” and “outer” refer to relative directions with respect to the interior and exterior of an appliance, and in particular the chamber(s) defined therein. For example, “inner” or “inward” refers to the direction towards the interior of the appliance. Terms such as “left,” “right,” “front,” “back,” “top,” or “bottom” are used with reference to the perspective of a user accessing the appliance (e.g., when the door is in the closed position). For example, a user stands in front of the appliance to open a door and reaches into the internal chamber(s) to access items therein.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise, or counterclockwise, with the vertical direction V).

The present invention advantageously provides methods of directing repairs of an appliance that may provide appliance-specific instructions to perform a repair using an image of a portion of the appliance overlayed with at least one instructional graphic. Advantageously, a user may be more readily able to perform repairs or maintenance on household appliances by using the appliance-specific instructions. In some embodiments, the systems and methods described herein may advantageously perform a confirmation test to check whether a repair performed by a user has been performed correctly. Systems and methods described herein may advantageously provide a way to allow inexperienced users to perform maintenance and repairs without having to call a repair technician. Additionally or alternatively, systems and methods described herein may allow the creation of an appliance history database that may be updated with current parts and repair history as repairs or maintenance activities are performed by the user.

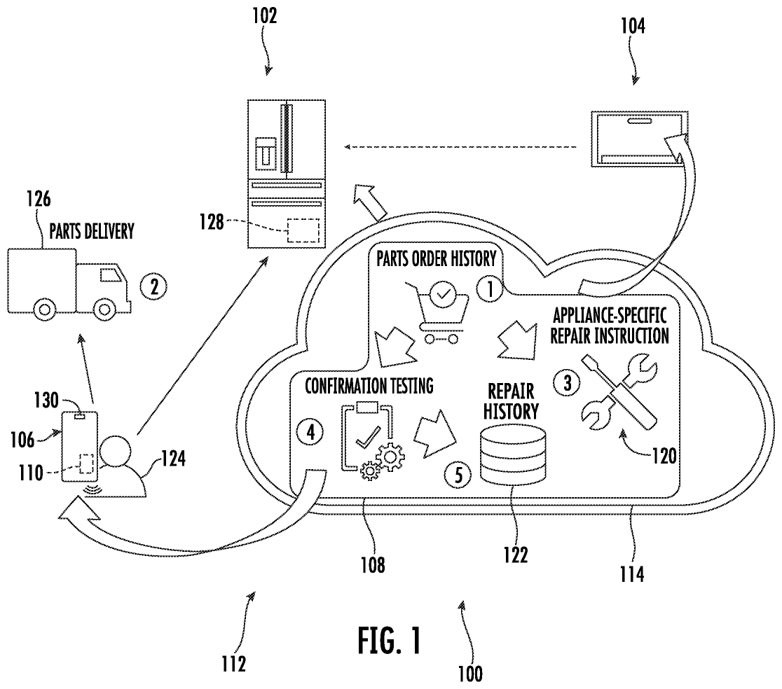

Referring now to FIG. 1, an appliance repair instruction system 100 will be described according to exemplary embodiments of the present subject matter. In general, appliance repair instruction system 100 may include any suitable number, type, and configuration of appliances, remote servers, network devices, and/or other external devices that are able to communicate with each other or are otherwise interconnected. This interconnection, interlinking, and interoperability of multiple appliances and/or devices may commonly be referred to as “smart home” or “connected home” appliance interconnectivity.

This communication may be achieved using any suitable communication protocols and interfaces, such as one or more wireless networks, to transfer useful information or data. For example, interconnected appliances or remote user devices may share consumer usage data, user preferences, appliance operating parameters, operating conditions, and/or other useful data or information. Sharing data between and among various appliances or other devices within the appliance repair instruction system 100 may result in improved overall system operation, including improved efficiency and performance of each appliance individually and/or all appliances collectively. In addition, user interaction, monitoring, control, and overall satisfaction with the appliance repair instruction system 100 may be enhanced.

FIG. 1 illustrates an appliance repair instruction system 100 according to exemplary embodiments of the present subject matter. As shown, appliance repair instruction system 100 generally includes a first appliance 102 (e.g., illustrated herein as a refrigerator appliance) and may include a second appliance 104 (e.g., illustrated herein as a microwave appliance. First appliance 102 and optional second appliance 104 will be described below according to exemplary embodiments of the present subject matter. However, it should be appreciated that the specific appliance types and configurations are only exemplary and are provided to facilitate discussion regarding the use and operation of an exemplary appliance repair instruction system 100. The scope of the present subject matter is not limited to the number, type, and configurations of appliances set forth herein.

For example, the appliance repair instruction system 100 may include any suitable number and type of “appliances,” such as “household appliances.” These terms are used herein to describe appliances typically used or intended for common domestic tasks, e.g., such as kitchen appliances as illustrated in the figures. According to still other embodiments, these “appliances” may include but are not limited to a refrigerator, a dishwasher, a microwave oven, a cooktop, an oven, a washing machine, a dryer, a water heater, a water filter or purifier, an air conditioner, a space heater, and any other household appliance which performs similar functions in addition to network communication and data processing. Moreover, although only two appliances are illustrated, various embodiments of the present subject matter may also include three or more appliances, each of which may transmit, receive, and/or relay signals among connected appliances and/or other external devices.

In addition, it should be appreciated that appliance repair instruction system 100 may include one or more external devices, e.g., devices that are separate from or external to the one or more appliances, and which may be configured for facilitating communications with various appliances or other devices. For example, according to exemplary embodiments of the present subject matter, the appliance repair instruction system 100 may include or be communicatively coupled with a remote user device 106 that may be configured to enable user interaction with some or all appliances or other devices in the appliance repair instruction system 100. In general, remote user device 106 may be any suitable device separate and apart from appliances (e.g., such as first appliance 102 or second appliance 104) that is configured to provide and/or receive communications, information, data, or commands from a user. In this regard, remote user device 106 may be an additional user interface to the user interface panels of the various appliances within the appliance repair instruction system 100. In this regard, for example, the remote user device 106 may be a personal phone, a smartphone, a tablet, a laptop or personal computer, a wearable device, a smart home system, or another mobile or remote device. For example, the separate device may be a smartphone operable to store and run applications, also known as “apps,” and the remote user device 106 be provided as a smartphone app. Additionally or alternatively, remote user device 106 may have access to or be operable to store information on one or more databases.

In addition, as will be described in more detail below, the appliance repair instruction system 100 may include or be communicatively coupled with a remote server 108 that may be in operative communication with remote user device 106 and/or some or all appliances within appliance repair instruction system 100. Thus, remote user device 106 and/or remote server 108 may refer to one or more devices that are not considered household appliances as used herein. In addition, devices such as a personal computer, router, network devices, and other similar devices whose primary functions are network communication and/or data processing are not considered household appliances as used herein.

As illustrated, each of first appliance 102, second appliance 104, remote user device 106, or any other devices or appliances in appliance repair instruction system 100 may include or be operably coupled to a controller, identified herein generally by reference numeral 110. As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 110 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 110 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware.

Additionally, or alternatively, the instructions can be executed logically and/or virtually using separate threads on one or more processors.

For example, controller 110 may be operable to execute programming instructions or micro-control code associated with an operating cycle of an appliance. In this regard, the instructions may be software or any set of instructions that when executed by the processing device, cause the processing device to perform operations, such as running one or more software applications, displaying a user interface, receiving user input, processing user input, etc. Moreover, it should be noted that controller 110 as disclosed herein is capable of and may be operable to perform any methods, method steps, or portions of methods as disclosed herein. For example, in some embodiments, methods disclosed herein may be embodied in programming instructions stored in the memory and executed by controller 110. For example, a controller 110 of system 100 may be a non-transitory computer readable medium comprising computer-executable instructions, which, when executed by one or more processors of a computing system may cause one or more processors to perform methods described herein (e.g., appliance repair instruction method 200, which will be described in more detail below). The memory devices may also store data that can be retrieved, manipulated, created, or stored by the one or more processors or portions of controller 110. The data can include, for instance, data to facilitate performance of methods described herein. The data can be stored locally (e.g., on controller 110) in one or more databases and/or may be split up so that the data is stored in multiple locations. In addition, or alternatively, the one or more database(s) can be connected to controller 110 through any suitable communication module, communication lines, or network(s).

Referring still to FIG. 1, a schematic diagram of an external communication system 112 will be described according to an exemplary embodiment of the present subject matter. In general, external communication system 112 is configured for permitting interaction, data transfer, and other communications between and among first appliance 102, second appliance 104, remote user device 106, remote server 108, other appliances within appliance repair instruction system 100, and/or one or more external devices. For example, this communication may be used to provide and receive operating parameters, cycle settings, user instructions or notifications, performance characteristics, user preferences, or any other suitable information for improved performance of one or more appliances within appliance repair instruction system 100. In addition, it should be appreciated that external communication system 112 may be used to transfer data or other information to improve performance of one or more external devices or appliances and/or improve user interaction with such devices.

In addition, remote server 108 may be in communication with an appliance (e.g., appliance 102 or 104) and remote user device 106 through a network 114. In this regard, for example, remote server 108 may be a cloud-based server 108, and is thus located at a distant location, such as in a separate state, country, etc. According to an exemplary embodiment, remote user device 106 may communicate with a remote server 108 over network 114, such as the Internet, to transmit/receive data or information, provide user inputs, receive user notifications or instructions, interact with, or control the appliance, etc. In addition, remote user device 106 and remote server 108 may communicate with the appliance to communicate similar information.

In general, communication between an appliance, remote user device 106, remote server 108, or other user devices or appliances may be carried using any type of wired or wireless connection and using any suitable type of communication network, non-limiting examples of which are provided below. For example, remote user device 106 may be in direct or indirect communication with the appliance through any suitable wired or wireless communication connections or interfaces, such as network 114. For example, network 114 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 112 is described herein according to an exemplary embodiment of the present subject matter. However, it should be appreciated that the exemplary functions and configurations of external communication system 112 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Still referring to FIG. 1, first appliance 102 will be described according to an exemplary embodiment of the present subject matter.

First appliance 102 may be provided as a refrigerator appliance that defines one or more chilled chambers for receipt of food items for storage. First appliance 102 may have a number of components, which may include a control board. The control board may house the controller (e.g., controller 110) which may be configured to perform functions. In some embodiments, the control board may include an appliance profile. The appliance profile may include various user-selected settings, after-sale features (including downloadable applications or after-sale software enhancements), or operational parameters specified by a user 124. For example settings selected by user 124 may include a temperature setting for each chilled chamber of first appliance 102, a humidity setting, ice maker settings, or other settings as would be understood. After-sale features may include improvements to software kept on control board or controller 110, including recipe software or customizable features, as would be understood. Operational parameters may include reminders for maintenance, religious settings such as shabbat settings, humidity levels, air flow levels, or other parameters as would be understood. In embodiments with other appliances 102, appliance settings, after-sale features, or operational parameters may correspond to the specific appliance 102, as would be understood. For example, an oven appliance may have appliance settings related to oven temperature or timed cooking, etc. In some examples, appliance profile of appliance 102 may further be saved to remote server 108 by way of network 114.

Second appliance 104 may be a “smart” appliance, with a controller and network interface (not shown) capable of communicating with remote network 114, remote server 108, or remote user device 106. Further, if first appliance 102 has limited communication abilities, but can connect to second appliance 104, second appliance 104 may serve to direct first appliance 102 to perform actions such as confirmation testing, which will be described in more detail below.

Now that the construction of appliance repair instruction system 100, first appliance 102, second appliance 104, and external communication system 112 have been presented according to exemplary embodiments, an exemplary method 200 of operating a system of household appliances will be described. Although the discussion below refers to the exemplary method 200 of operating appliance repair instruction system 100, one skilled in the art will appreciate that the exemplary method 200 is applicable to the monitoring, control, utilization, or interconnectivity of any suitable number, type, and configuration of appliances. In exemplary embodiments, the various method steps as disclosed herein may be performed by one or more controllers (e.g., such as controllers 110) or by a separate, dedicated controller that may be located locally on one or more of the appliances, remotely on a remote server, etc.

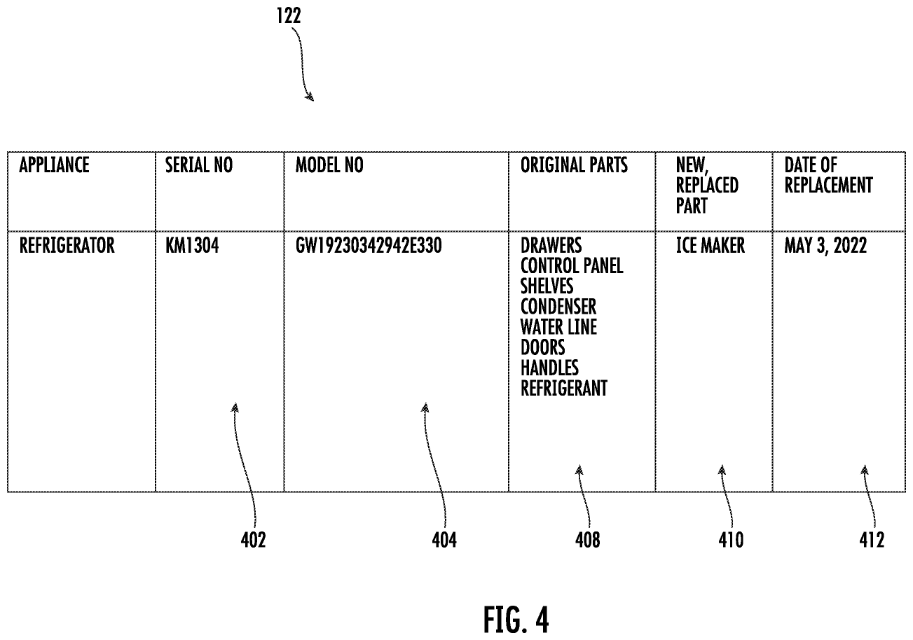

Turning generally to FIGS. 1 through 5, various methods may be provided for use of a system (e.g., system 100), appliance (e.g., first appliance 102), or remote server (e.g., remote server 108) in accordance with the present disclosure. In general, the various steps of methods as disclosed herein may, in exemplary embodiments, be performed by one or more controllers 110 (e.g., of remote user device 106, second appliance 104 or remote server 108) as part of an operation that a controller 110 is configured to execute (e.g., as, or as part of, a repair instruction operation). During such methods, the controller 110 may receive inputs and transmit outputs from various other components or external devices. In particular, the present disclosure is further directed to methods, such as communicating appliance-specific repair instructions 120 for maintenance on a household appliance (e.g., first appliance 102). In certain embodiments, such methods may advantageously facilitate customized, step-by-step guided instructions for performing appliance repairs, confirming correct repairs are performed, and accounting for repairs in an appliance repair history 122 (e.g., appliance repair history 122 shown in FIG. 4), making user repair of appliances easier or more straightforward.

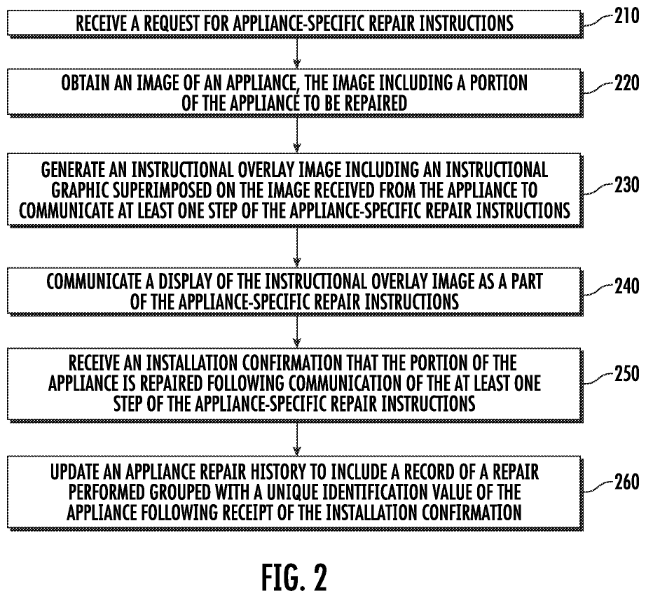

Turning to FIGS. 2 through 4, the method 200 may be performed by controller 110, for example, of remote server 108 to communicate step-by-step instructions on performing a repair or maintenance of appliance 102. Method 200 is intended to capture actions performed by a remote server, such as remote server 108. For example, remote server 108 may direct actions toward remote user device 106 or towards appliance 102, as will be described in more detail below.

At 210, the method 200 includes receiving a request for appliance-specific repair instructions 120. For example, remote server 108 may receive the request for appliance-specific repair instructions 120 from a remote user device 106. For example, the user 124 may provide inputs via remote user device 106 which are received by remote server 108. In some embodiments, remote user device 106 may transmit the request for appliance-specific repair instructions 120. Additionally or alternatively, remote server 108 may receive the request for appliance-specific repair instructions 120 from an appliance (e.g., first appliance 102 or second appliance 104).

In some examples, appliance-specific repair instructions 120 may be a guide to remove and replace a component 150 of appliance 102. The component 150 to be replaced may be any component of the system, including components connected to electrical systems of appliance 102 (e.g., control board, condenser, actuators, etc.), and components with only mechanical functions (e.g., door handles, gears, shelves, etc.).

Additionally or alternatively, appliance-specific repair instructions 120 may be a guide to perform maintenance on one or more components of appliance 102. For example, refrigerator appliance 102 may require periodic dust removal of condenser components. Other instructions may also be provided for other maintenance activities for appliances, as would be understood.

Generally, appliance-specific instructions 120 may be specific to appliance 102. For example, appliance-specific instructions 120 may be tailored to the model number, or serial number of appliance 102. Additionally, appliance-specific instructions 120 may be tailored using at least one image of the appliance 102 received during method 200, as will be described in more detail below. For example, appliance-specific instructions 120 may be a guide to direct a user 124, including a user 124 inexperienced with appliance repair, to perform removal of a component in appliance 102 and installation of a new component to replace the removed component. Such guide may include removal of outer panels or other components of appliance 102 to access the component 150 to be removed.

In some embodiments, the method may further include receiving an order for a new component specific to the appliance 102, confirming the new component is correct for the appliance 102, or directing shipment of the new component. For example, step 210 may include receiving a request from a user 124 to order a new component, which may be directed to a remote server 108 via network. In some embodiments, receiving a request to order a new component may constitute a request for appliance-specific repair instructions 120 from a user 124.

In some embodiments, the method 200 may further include comparing the new component ordered to an appliance component database for first appliance 102. In some embodiments, if an incorrect new component is ordered, the method 200 may include recommending a corrected new component similar to the new component requested. In some embodiments, method 200 may further include directing shipment of the new component.

In some embodiments, the method 200 may include receiving a delivery confirmation of a new component to the user 124, as shown by parts delivery 126 in FIG. 1. Parts delivery confirmation may be received from a user 124 or may be received based on a remote server 108, including a parts delivery system or service 126, which may be external or internal to system 100.

In some embodiments, appliance-specific repair instructions 120 may be requested for maintenance or a repair that does not require a new component. In such cases, step 210 may be synonymous with or directly prior to step 220.

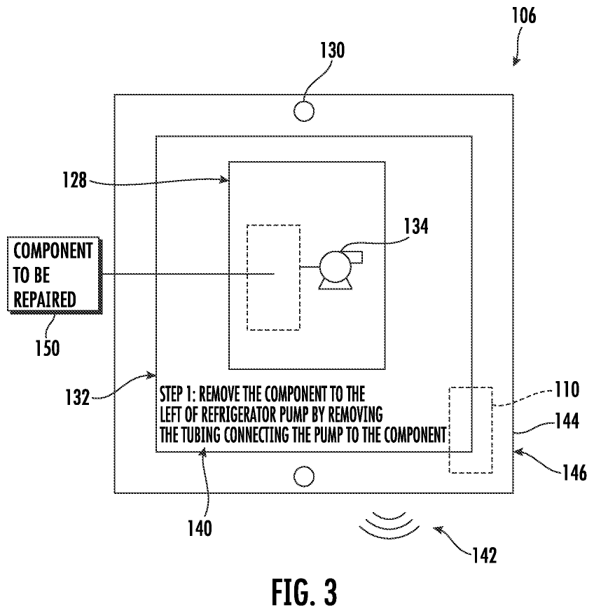

At step 220, the method 200 may include obtaining an image (not shown) of the appliance. In some embodiments, the image may include a portion 128 of the appliance (e.g., first appliance 102) to be repaired following receipt of the request. As shown in FIGS. 1 and 3, a camera assembly 130 from user device 106 may supply image of the appliance. User 124 may direct the camera assembly 130 to capture the image of the portion 128 of the appliance 102. In some embodiments, the image obtained of the appliance 102 may include the part to be replaced or the portion of the appliance 102 upon which maintenance is to be performed.

Generally, camera assembly 130 may be any type of device suitable for capturing at least one image or video. As an example, camera assembly 130 may be a video camera or a digital camera with an electronic image sensor [e.g., a charge coupled device (CCD) or a CMOS sensor]. Although the term “image” is used herein, it should be appreciated that according to exemplary embodiments, camera assembly 130 may take any suitable number or sequence of two-dimensional images, videos, or other visual representations of appliance 102 or components of appliance 102. For example, the one or more images may include a video feed, or a series of sequential static images obtained by camera assembly 130 that may be transmitted to controller 110 (e.g., as a data signal) for analysis or other manipulation. In some embodiments, camera assembly 130 transmits images or video feed directly to user device 106 (e.g., through wireless signal). Optionally, one or more light sources (not shown) may be provided with or adjacent to the camera assembly 130. During use, camera assembly 130 may take images or video feed in coordination with the light sources such as to obtain higher quality or truer-to-color images of appliance 102 or items therein or thereon.

At step 230, the method 200 may include generating an instructional overlay image including an instructional graphic 134 associated with the image received of the appliance to communicate at least one step of the appliance-specific repair instructions 120. For example, instructional overlay image 132 may include the image received in step 220, with an instructional graphic 134 overlayed on the image received in step 220. Instructional overlay image 132 may be prepared by controller or by remote server 108 and communicated to user device 106 using network.

Instructional graphic 134 may be overlayed on top of the image of the appliance received at step 220. In some embodiments, instructional graphic 134 may be a depiction of a three dimensional image. Optionally, instructional graphic 134 may include a set of images or video. Instructional graphic 134 may be a picture of a component 150 to be replaced, for example, and as shown in FIG. 3. In some embodiments, instructional graphic 134 may be a video graphic depiction of removing a portion of appliance. In some embodiments, instructional graphic 134 may depict a step of appliance-specific repair instructions 120. For example, instructional graphic 134 may depict a step of removing component 150, such as an electrical component from an electrical boss in preparation for removing component 150 from the appliance 102. In additional or alternative embodiments instructional graphic 134, maybe a static image overlaid on top of the image received in step 220, depicting a visual instruction such as the pump graphic 134 shown in FIG. 3.

In some examples, instructional graphic 134 may include a depiction of a three dimensional image, such as an image of the new component to be installed. In some examples, instructional graphic 134 may include a set of images or video. In this manner, instructional overlay image 132 may depict a position, manner of installation, or other visual representation of how to place new component in appliance.

At step 240, the method 200 may include communicating the instructional overlay image 132 as a part of the appliance-specific repair instructions 120. In some embodiments, the instructional overlay image 132 including the instructional graphic 134 may be communicated to user device 106 from remote server 108. In some embodiments, the instructional overlay image 132 may be communicated to second appliance 104.

Additionally or alternatively, text instructions 140 or audio instructions 142 may be communicated with the communication of the instructional overlay image. For example, the method 200 may include communicating text instructions 140 or audio instructions 142 with the communication of the instructional overlay image. Text instructions 140 or audio instructions 142 may include guided instructions for repair or maintenance of the first appliance 102. For example, text may overlap or overlay on top of the image received, as shown in FIG. 3.

In some embodiments, multiple images may be received, and multiple instructions may be sent, as a part of method 200. Hence, repeated receipt of images and communication of instructional overlay images may give detailed guided instructions. These guided instructions may be adjusted depending on the experience or communication of images by the user 124. Advantageously, the appliance-specific repair instructions 120 may be customized with repeated steps of obtaining an image, generating an instructional overlay image, and communicating the instructional overlay image 132 as a part of the appliance-specific repair instructions 120.

Additionally, or alternatively, one image may be obtained, and multiple instructional graphics may be added or removed, and the instructional overlay image 132 may be resent with different instructional graphics during different steps of the appliance-specific repair instructions 120. For example, a first instructional overlay image may show removal of a first component of appliance 102. A second instructional overlay image may show installation of a new component to replace the first component. Steps to remove components may include intermediary steps, such as removal of outer panels, followed by replacement of outer panels, as would be understood to be part of some maintenance during the course of a repair.

In some embodiments, the method 200 may include receiving confirmation that one or more steps in the appliance-specific repair instructions 120 have been completed prior to the step of communicating additional instructional overlay images or the step of communicating additional steps in the appliance-specific repair instructions 120.

Following completion of sending appliance-specific repair instructions 120, the method 200 may include confirming installation is complete. At step 250, method 200 may include receiving an installation confirmation that a portion 128 of the appliances repaired following communication of the instructional overlay image 132. For example, a user 124 may send an installation confirmation to remote server 108. In some embodiments, an installation confirmation may be received at the user device 106. In certain embodiments, sending a prompt from remote server 108 to the user device 106 asking a user 124 to confirm installation may precede receipt of the installation confirmation.

Following receipt of the installation confirmation, the method 200 may include directing the performance of a confirmation test at the appliance. The confirmation test may be configured to ensure repair of the appliance 102 was performed properly. If the appliance 102 was repaired with an electrical connection, a connectivity test may be performed. If the appliance 102 was repaired without using electrical systems, a static confirmation test may be performed.

The connectivity test may be used to detect at least one electrical component has been properly connected prior to receipt of the installation confirmation. The connectivity tests may additionally confirm proper repair of the appliance 102. For example, if a part was removed and replaced that connects to the controller (e.g., a controller of appliance 102), the connectivity test may confirm that the controller has operative control of the new component during the connectivity test. In some embodiments, that kind of activity test may include sending electrical signals through the portion 128 of the appliance 102 that was repaired and checking current levels or voltage levels and comparing those to a standard current or voltage level for appliance 102. Other equivalent tests to confirm the new component is properly installed and connected to the controller may also be used, as would be understood.

The static confirmation test may be performed by requesting an installation confirmation image from a user 124. In some embodiments, method 200 may further include the step of receiving an installation confirmation image from the remote user device 106 received by the remote server 108. In some examples, remote server 108 sends a request for action or a user prompt to user device 106 requesting an installation confirmation image, the installation showing the user's completed attempt at repairing appliance 102. In response, user 124 uses remote user device 106 and the camera assembly 130 located thereon to obtain an installation confirmation image of the completed attempt at the repair and sends the installation confirmation image to the remote server 108. Remote server 108 receives the installation confirmation image from user device 106. Remote server 108 then measures at least one dimension depicted in the installation confirmation image and compares that to a dimension standard held on remote server 108 to determine if the user's completed attempt to repair appliance 102 was performed correctly. In some examples, determining if the completed repair was performed correctly includes determining if the measured dimension is roughly equal to the dimension standard, and if so, the appliance repair is deemed to have been performed correctly.

The installation confirmation imaged may depict the portion 128 of the appliance 102 upon which a repair has been performed. In some embodiments, the confirmation test may include measuring at least one dimension depicted in the installation confirmation image and comparing the at least one dimension to a dimension standard to confirm the repair. For example, if a component was installed correctly, it would have dimensions relative to other components when reviewed in an image that could be compared to a dimension standard for the appliance 102. In some embodiments, a distance between components may also be used when comparing the installation confirmation image to a dimensional standard to confirm the repair. For example, replacing a handle may include screwing a handle onto a door of the appliance. If the handle is installed correctly, the handle would have a dimensional standard distance from the door, and that could be compared to a dimension measured from the installation confirmation image to determine if the handle is correctly installed. In some embodiments, more than one dimension may be verified in the confirmation test.

In some embodiments, second appliance 104 may communicate with first appliance 102 to perform the confirmation test. The method 200 may include communicating with second appliance 104 to direct the performance of the confirmation test of first appliance 102. For example, if first appliance 102 has limited connectivity, but is capable of connecting and receiving direction from second appliance 104, second appliance may be able to communicate or direct the performance of connectivity tests at first appliance 102 in response to second appliance receiving a request from user device 106 or remote server 108 to direct testing at first appliance 104. Second appliance 104 may have broader connectivity, and be able to communicate with network, user device 106 and first appliance 102. Thus, second appliance 104 may direct the performance of the connectivity test of first appliance 102. Advantageously, using differing connectivity may allow more appliances to use this method and have proper installation confirmed, despite limited connectivity to a cloud or remote network 114.

Optionally, the method 200 may include steps to remove and replace a control board of the appliance 102. For example, the appliance-specific repair instructions 120 may include instructions on removing and replacing a control board of the appliance 102. In this manner, the step 250 of receiving the installation confirmation may further include receiving notice that a new control board has been installed in the appliance 102. In embodiments where a control board replacement is performed, the method 200 may further include uploading the appliance profile onto the new control board. For example, the appliance profile, as described herein, may be uploaded onto the new control board from a remote server 108 using the network. In some embodiments, the appliance profile may be saved on the user device 106 prior to step 210, receiving the request for appliance-specific repair instructions 120. Thus, the appliance profile may be downloaded onto the new control board from the user device 106. The step of uploading the appliance profile onto the new control board may follow receipt of the installation confirmation. As previously discussed, the appliance profile may comprise at least one customized setting, at least one after-sale feature, or at least one operational parameter for the appliance, any, or all of which may be uploaded onto the new control board.

Returning to the method 200 generally, at step 260, the method 200 may further include updating an appliance repair history 122 (e.g., repair history 122 in FIG. 4) to include a record of the repair performed. The record of the repair performed may be grouped with a unique identifier 402 (e.g., serial number 402 in FIG. 4) specific to the appliance 102. The appliance repair history 122 may be a database accessed on network 114.

Step 260 may follow receipt of the installation confirmation. The unique identifier 402 may be a serial number 402 or other identifying name, character, etc. that is specific to the appliance 102. As shown in FIG. 4, a serial number 402 identifies appliance 102. Further, a model number 404 is grouped with the serial number 402 in the repair history 122. As shown in FIG. 4, repair history 122 may include an original parts list 406. A record of the repair performed, as shown by the new replaced part 410 and date of replacement 412 in repair history 122 may be grouped with the unique identifier 402 at step 260. Advantageously, the repair history 122 may serve as a record of the current parts and repairs made to each appliance of the system 100. Further, multiple users may use the repair history 122 for their appliances, or many repair histories 122 may be generated individually for each appliance of the system 100. The repair history 122 may follow each appliance between users as well. Thus, any user 124 may be aware of the current state and repairs previously performed on any appliance of the system 100 or methods as described herein.

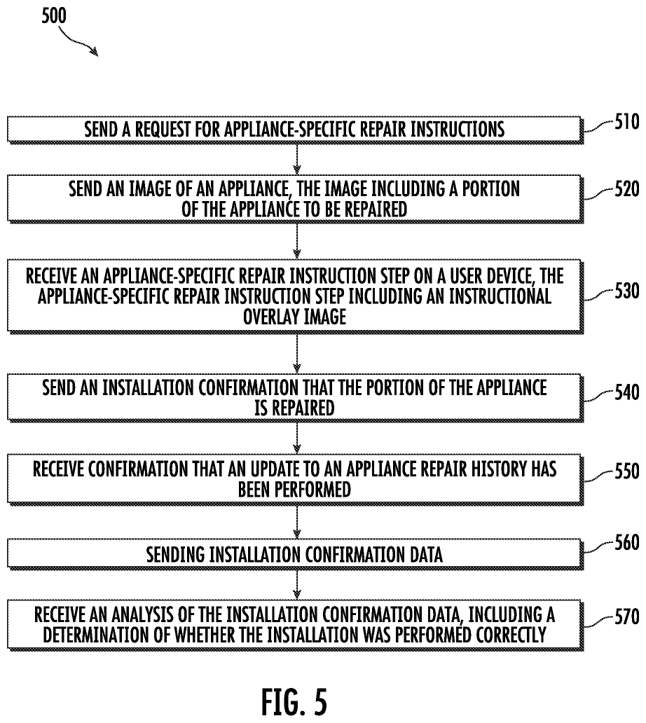

Turning to FIG. 5, a method 500 for directing the user 124 to perform repairs on an appliance will be described. Steps may be similar or have features similar to the systems and methods already herein described. In some examples, a controller 110, such as a controller of user device 106, may perform the steps of method 500.

At step 510, the method 500 may sending a request for appliance-specific repair instructions 120. For example, user device 106 may send a request to remote server 108 by using network 114 for appliance-specific repair instructions 120. At step 520, the method 500 may include sending an image of the appliance, the image including a portion 128 of the appliance to be repaired. The user device 106 may send the image of the appliance to remote server 108. At step 530, the method 500 may include receiving an appliance-specific repair instruction step on a user device 106. The user device 106 may receive the appliance-specific repair instruction step from remote server 108. The appliance-specific repair instruction step may include an instructional overlay image 132. The overlay image 132 as described previously, may include an instructional graphic 134 associated with the image of the appliance 102 previously sent. The instructional graphic 134 may communicate at least one step of the appliance-specific repair instructions 120.

At step 540, the method 500 may include sending an installation confirmation that the portion 128 of the appliance 102 is repaired following receipt of the at least one step of the appliance-specific repair instructions 120. User device 106 may send the installation confirmation to the remote server 108. At step 550, the method 500 may include receiving confirmation that an update to an appliance repair history 122 (e.g. repair history 122 in FIG. 4) has been performed in response to sending the installation confirmation period. The appliance repair history 122 as described herein may include a record of the repair performed, grouped with a unique identification value of the appliance 102. The confirmation that an updated to the appliance repair history 122 may be received by the user device 106 from remote server 108. In some embodiments, the method 500 may include at step 560, sending installation confirmation data from user device 106 to remote server 108. Remote server 108 may analyze installation confirmation data to confirm the repair was performed correctly at appliance 102 by user 124. Further, in some embodiments, the method 500 may include at step 570 receiving an analysis of the installation confirmation data from remote server 108, including a determination of whether installation was performed correctly. User device 106 may receive the analysis from the remote server 108. Such steps of method 500 may be performed similar to the system and methods as described herein.

In some embodiments, appliance-specific repair instructions 120 for method 500 include instructions on removing and replacing a control board of the appliance 102. In this manner, sending the installation confirmation at step 540 may include sending confirmation that a new control board has been installed in the appliance 102. The method 500 may further include uploading an appliance profile onto the new control board following receipt of the installation confirmation according to methods and systems described herein. The appliance profile may include at least one customize setting, at least one after-sale feature, or operational parameters for the appliance previously described.

Embodiments described herein may further relate to appliance-guided installation confirmation systems and methods. In specific, systems described herein may use augmented reality to enable users to have self-installation of appliance parts and users may be able to use a step-by-step guide and customized confirmation testing. Advantageously, systems and methods described herein may make self-installation fast, easy, or less prone to error. When user 124 places an order for appliance parts, the system may remember the components that were ordered and confirm that the new components ordered fit appliance 102. Once the new components arrive, user device 106, which may utilize a mobile application or mobile app, may provide an augmented reality based step-by-step guide (also referred to herein as appliance-specific repair instructions 120) on how to install the components. User 124 may be able to follow a virtual technician. Finally, user 124 can initiate customized confirmation testing to make sure the repaired appliance 102 is functioning as designed.

Remote user devices (e.g., user device 106) may use the appliance-specific repair instructions 120 or guide online or offline. The guide may be customized for appliance 102 on which user 124 may put the ordered new components. For each of the installation steps, virtual three dimensional images of the new components are overlayed over images obtained from camera assembly 130 of user device 106. Audio messages or text messages (e.g., text instructions 140 or voice instructions 142) may be used to provide more detailed instructions. This design may allow users to follow an augmented reality demonstration of the whole installation and may reduce the risk of error in the process.

Depending on the components being installed, a customized confirmation testing process may be used or generated. For completely mechanical installations, the user device 106 may measure one or more related dimensions to make sure components of appliance 102 are in the right place following installation. For installations with any electrical connections, comprehensive confirmation testing may be initialized, and the results of the confirmation test may be analyzed (e.g., by remote server 108 or through network 114). In some embodiments, for users who follow a paper-based text installation guide, confirmation testing could be initialized from certain existing connected appliances in the same household. In this, a Bluetooth® or Wi-Fi® connection may be established between the two appliances first and the existing connected appliance 102 will have a display 144 with a user interface 146.

After the new installation is confirmed by the confirmation testing, the information of the new parts may be automatically added to the repair history database 122. In the case of a control board replacement, not only will repair history 122 be updated, but also the new control board may be loaded with the appliance's up-to-date profile data from the network or remote server 108. Advantageously, this design may ensure that the old control board's customized information, such as customer settings, after-sales features, and operational parameter values, are not lost with control board replacement.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An appliance repair instruction method for directing a user to perform a repair on an appliance, the method comprising the steps of:
receiving a request for appliance-specific repair instructions;
obtaining an image of the appliance, the image including a portion of the appliance to be repaired following receipt of the request;
generating an instructional overlay image including an instructional graphic associated with the image received of the appliance to communicate at least one step of the appliance-specific repair instructions; and
communicating the instructional overlay image as a part of the appliance-specific repair instructions.

2. The appliance repair instruction method of claim 1, further comprising:
receiving an installation confirmation that the portion of the appliance is repaired following communication of the instructional overlay image.

3. The appliance repair instruction method of claim 2, further comprising:
updating an appliance repair history to include a record of the repair performed grouped with a unique identifier specific to the appliance following receipt of the installation confirmation.

4. The appliance repair instruction method of claim 2, further comprising:
directing the performance of a confirmation test at the appliance following receipt of the installation confirmation, the confirmation test configured to ensure repair of the appliance was performed properly.

5. The appliance repair instruction method of claim 4, wherein the confirmation test comprises a connectivity test to detect that at least one electrical component has been properly connected prior to receipt of the installation confirmation, and to confirm proper repair of the appliance.

6. The appliance repair instruction method of claim 4, further comprising:
receiving an installation confirmation image, the installation confirmation image depicting the portion of the appliance upon which a repair has been performed,
wherein the confirmation test comprises measuring at least one dimension depicted in the installation confirmation image, comparing the at least one dimension to a dimension standard to confirm the repair.

7. The appliance repair instruction method of claim 4, further comprising:
communicating with a second appliance to direct the performance of the confirmation test at the appliance.

8. The appliance repair instruction method of claim 1, further comprising:
receiving an order for a new component specific to the appliance;
confirming the new component is correct for the appliance; and
directing shipment of the new component.

9. The appliance repair instruction method of claim 1, wherein the appliance-specific repair instructions are a guide to remove and replace a component of the appliance.

10. The appliance repair instruction method of claim 1, wherein the instructional graphic includes a depiction of a three dimensional image.

11. The appliance repair instruction method of claim 1, wherein the instructional graphic includes a set of images or video.

12. The appliance repair instruction method of claim 1, further comprising:
communicating text instructions or audio instructions with the communication of the instructional overlay image.

13. The appliance repair instruction method of claim 2, wherein the appliance-specific repair instructions further comprise instructions on removing and replacing a control board of the appliance, and
wherein receiving the installation confirmation comprises receiving notice that a new control board has been installed in the appliance.

14. The appliance repair instruction method of claim 13, further comprising:
uploading an appliance profile onto the new control board following receipt of the installation confirmation, the appliance profile comprising at least one customized setting, at least one after-sale feature, or at least one operational parameter for the appliance.

15. An appliance repair instruction method for directing a user to perform repairs on an appliance, the method comprising the steps of:
sending a request for appliance-specific repair instructions;
sending an image of the appliance, the image including a portion of the appliance to be repaired; and
receiving an appliance-specific repair instruction step on a user device, the appliance-specific repair instruction step including an instructional overlay image, the overlay image comprising an instructional graphic associated with the image of the appliance sent, the instructional graphic communicating at least one step of the appliance-specific repair instructions.

16. The appliance repair instruction method of claim 15, the method further comprising the steps of:
sending an installation confirmation that the portion of the appliance is repaired following receipt of the at least one step of the appliance-specific repair instructions; and
receiving confirmation that an update to an appliance repair history has been performed in response to sending the installation confirmation, the appliance repair history including a record of the repair performed grouped with a unique identification value of the appliance.

17. The appliance repair instruction method of claim 15, wherein the appliance-specific repair instructions further comprise instructions on removing and replacing a control board of the appliance, and wherein sending an installation confirmation comprises sending confirmation that a new control board has been installed in the appliance, and
wherein the appliance repair instruction method further comprises uploading an appliance profile onto the new control board following receipt of the installation confirmation, the appliance profile including at least one customized setting, at least one after-sale feature, or operational parameters for the appliance.

18. The appliance repair instruction method of claim 15, further comprising:
sending installation confirmation data; and
receiving an analysis of the installation confirmation data including a determination of whether installation was performed correctly.

19. A non-transitory computer readable medium comprising computer-executable instructions, which, when executed by one or more processors of a computing system having a controller, cause the one or more processors of the controller to:
receive a request for appliance-specific repair instructions;
obtain an image of an appliance, the image including a portion of the appliance to be repaired following receipt of the request;
generate an instructional overlay image including an instructional graphic superimposed on the image received of the appliance to communicate at least one step of the appliance-specific repair instructions;
communicate a display of the instructional overlay image as a part of the appliance-specific repair instructions;
receive an installation confirmation that the portion of the appliance is repaired following communication of the at least one step of the appliance-specific repair instructions; and
update an appliance repair history to include a record of a repair performed grouped with a unique identification value of the appliance following receipt of the installation confirmation.

20. The non-transitory computer readable medium of claim 19, the one or more processors further configured to:
receive an order for a new component specific to the appliance;
direct shipment of the new component; and
receive confirmation of delivery of the new component prior to obtaining the image of the appliance.
